(19) United States
(12) Patent Application Publication
(10) Pub. No.: US 2014/0191052 A1
(43) Pub. Date: Jul. 10, 2014

(54) Steel Rail Solar Radiation Sheilding

(71) Applicants: James Shelton, Alpine, TX (US); Keith A. Langenbeck, Pleasant View, TN (US)

(72) Inventors: James Shelton, Alpine, TX (US); Keith A. Langenbeck, Pleasant View, TN (US)

(21) Appl. No.: 14/150,668

(22) Filed: Jan. 8, 2014

Related U.S. Application Data
(60) Provisional application No. 61/848,672, filed on Jan. 8, 2013.

(51) Int. Cl. E01B 5/02; B05D 5/00

(52) U.S. Cl. CPC E01B 5/02; B05D 5/00
USPC 238/150; 427/372.2; 427/160

(57) ABSTRACT

A steel rail solar radiation shield comprises a coating applied to the steel rail configured to one of block, reflect and frequency shift solar radiation from being transferred to the steel rail via particulates suspended in the coating. The applied coating is configured to be self-cleaning via at least one of additional water, carbon dioxide, heat and an additional superficial sol coating configured to shed contaminates from the applied solar radiation shield coating. A solar radiation shield retains a ballast to block and reflect the solar radiation from the steel rail and have self-cleaning properties. Heat applied to an aqueous calcium to species forms a reformed solid surface. A superficial sol coating of titanium dioxide via a photo-catalysis yields ions which chemically remove common surface debris. Furthermore, a precipitated crystalline calcium sulfate hydrate bonds to the rail and produces a reformed and cleaned surface to shield the rails from solar radiation.

### CROSS-REFERENCE TO RELATED APPLICATION

This application claims the benefit of the priority date of earlier filed U.S. Provisional patent application Ser. No. 61/848,672, titled ‘Steel Rail Solar Radiation Shielding’ filed Jan. 8, 2013 by James A. Shelton and Keith A. Langenbeck, and is incorporated herein by reference in its entirety.

### BACKGROUND OF THE INVENTION

The predominant method for affixing consecutive sections of steel rail in modem train systems is butt-welding them together for a connected length that can be as much as 2000 feet or greater. The resultant single piece of welded rail is then installed onto tie plates and crossties. Continuous Welded Rail, aka CWR or ribbon rail, is considered to be stronger and less maintenance intensive than the historic method, which had a mechanical expansion joint approximately every 39 feet. It is the steel wheels of the train cars rolling over the gaps in the section joints that generate the signature “clickity-clack” sound familiar to train transportation.

There is an intrinsic and serious problem with CWR that does not occur with traditional sectioned rail with conventional expansion joints. Steel rail expands in length when heated and contracts in length when cooled. This thermal expansion or contraction can be significant enough to cause rail track failure in hot conditions by twisting out of shape (aka sun kinks) and even snap when contracting during cold conditions (aka pull-a-parts). During the hot summer months, train rail is routinely cut to relieve the built up stress and then re-welded. During the winter period the track has to be heated in order for pull-a-parts to be mended by re-welding. The unsolved problem of thermal stresses in CWR systems requires persistent, ongoing repair. It is common practice for inspectors to walk or ride track systems and physically examine the rail when the weather conditions warrant.

The thermal coefficient of expansion for steel is 0.00000645 inches of expansion/contraction per inch of length per degree of temperature change in Fahrenheit. For a one mile section of track and a 100-degree temperature variation the change in length for an unrestrained section of track is approximately 40.6 inches. It is possible for rail track sections in the American Midwest to experience an annual 200-degree temperature variation due to the low ambient winter temperatures in conjunction with elevated ambient summer temperatures and radiant heat absorbed from direct sunlight.

During July of 2012, there were numerous, serious instances of thermally induced failure to steel train rails. For example the Metro commuter rail system in Washington, DC had three cars derail with significant service interruptions and in Glenville, Ill. two people were killed when a Union Pacific coal train left the track. Relatedly, the Chicago Transit Authority operates special maintenance trains that spray water on elevated track sections during periods of extreme heat to reduce the risk of sunkink failures.

The negative consequences of thermal expansion in steel train rails occur not only during the extremes of ambient temperature, but in moderate weather situations as well. An example of the how much solar radiation can add to the actual rail temperature can be understood from the derailment of the Amtrak Train No. 48 near Flora, Miss. on Apr. 6, 2004 in which one person was killed and 60 were injured, 3 seriously. The National Transportation Safety Board computer animation video (Track Features—Flora, Mississippi Derailment from Thermal Expansion Sun Kink) can be found here: http://www.youtube.com/watch?v=BNHqvCqY2Hg. The ambient temperature on the day of the accident was 78 F. The rail temperature on the day of the accident was 114 F due to radiant heating from the sun. Assuming a 500-foot section of CWR track, the increase in length attributable to solar absorption is calculated as (0.00000645)×(6000 inches)×(36 F)=1.39 inches.

The technical solution to the thermal expansion problem had historically been to periodically install joints that expand and contract with the varying conditions, thereby eliminating temperature related steel rail failures. However, the currently offered thermal expansion joints, also known as breather joints, are very expensive. If used at all, these breather joints are located in high

value portions of the track system like bridges, curves and tunnels Minimizing or eliminating the thermal expansion attributed to solar radiation could avert many accidents and significantly lower operating costs.

### SUMMARY OF THE INVENTION

A steel rail solar radiation shield, comprises a coating applied to the steel rail configured to one of block, reflect and frequency shift solar radiation to from being transferred to the steel rail via particulates suspended in the coating.

The applied coating is configured to be self-cleaning via at least one of additional water, carbon dioxide, heat and an additional superficial sol coating configured to shed contaminates from the applied solar radiation shield coating.

The disclosure comprises a method of shielding a steel rail from solar radiation, comprising applying a solar radiation shield coating thereto and frequency shifting a wavelength of the solar radiation to a shorter wavelength radiation, the applied solar radiation shield coating containing Welsbach particulate configured to be self-cleaning by the application of at least one of additional water, carbon dioxide and heat. The disclosed method may include applying the solar radiation shield coating to a plurality of proximal components including tie plates, cross ties and a proximal portion of a ballast bed, the additional coating configured to impede solar radiation from heating the steel rail via conduction from the proximal track structures.

A solar radiation shield retains a ballast to block and reflect the solar radiation from the steel rail and have self-cleaning properties. Heat applied to an aqueous calcium species forms a reformed solid surface. A superficial sol coating of titanium dioxide via a photo-catalysis yields ions which chemically remove common surface debris. Furthermore, a precipitate of crystalline calcium sulfate hydrate bonds to the rail and produces a reformed and cleaned surface to shield the rails from solar radiation.

A steel rail solar radiation shield comprising a side wall retaining shield configured parallel to and distal to at least one rail, the side walls thereof extending to a height near a top of the rail(s) from a base for the rail(s) comprising a plurality of cross ties and a supporting structure for the rail(s), the side wall retaining shield configured to retain a ballast configured to block and reflect the solar radiation from the steel rail(s) and have self-cleaning properties. The ballast comprises a crushed white limestone rock disposed to block infrared radiation from all sides of the rails other than a top and a bottom surface of the rails in relation to the base, the limestone rock configured to comprise free calcium sulfate to hydrate in the rain water and yield crystalline calcium sulfate which mechanically bonds to the rail and chemically sheds contaminates in the water to continually produce an infrared radiation reflective shield.

Other aspects and advantages of embodiments of the disclosure will become apparent from the following detailed description, taken in conjunction with the accompanying drawings, illustrated by way of example of the principles of the disclosure.

### BRIEF DESCRIPTION OF THE DRAWINGS

FIG. 1 is an end depiction of a typical railroad rail and the surfaces coated with a solar radiation shield configured to shield the rail and be self-cleaning in accordance with an embodiment of the present disclosure.

FIG. 2 is a flow chart of a method for frequency shifting a solar radiation wavelength to a shorter wavelength via Welsbach particulate in the solar shield in accordance with an embodiment of the present disclosure.

FIG. 3 is a flow chart of a method for producing a self-cleaning and reflective crystalline aragonite and calcite shield in accordance with an embodiment of the present disclosure.

FIG. 4 is a flow chart of a method for producing a photo-catalytic titanium dioxide top coat shield that is self-cleaning in accordance with an embodiment of the present disclosure.

FIG. 5 is a flow chart of a method for producing a crystalline calcium sulfate hydrate shield that is self-cleaning in accordance with an embodiment of the present disclosure.

FIG. 6 depicts a front elevational view of a pair of installed rails and a side wall ballast retaining shield that has self-cleaning properties in accordance with an embodiment of the present disclosure.

Throughout the description, similar or same reference numbers may be used to identify similar or same elements in the several embodiments and drawings. Although specific embodiments of the invention have been illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure and continuances and/or divisional disclosures thereof, the term ‘shield,’ defines a coating or a covering such as a buttressed ballast which either blocks, reflects and/or frequency shifts solar radiation transferred to a rail. The term ‘sol coating’ defines a type of colloidal mineral suspension which settles out during or after application.

Unknown to the rail industry and described within this application is the use of specific coatings, paints or treatments applied to the exterior surfaces of the steel rail. The invention disclosed herein would include pigments such as titanium dioxide and calcium carbonate that reflect solar radiation along with other constituents of certain shapes and sizes known to block or interrupt solar radiation from being transferred to the underlying steel. The scope of this invention also anticipates the application of different surface treatments to the entire steel rail at the steel mill that would provide IR shielding.

Application of a radiant shield paint or coating to the exterior surface of the steel rails would work to prevent the internal rail temperature from rising above ambient. The solar radiation insulating coating would be sufficiently durable and flexible to maintain its integrity, attachment and functional benefit during thermal expansion/contraction and vertical flexing with the passing of the train car wheels. The scope of this invention also includes various means for cleaning, preparing and applying the coating to the rail, such as high pressure water jet nozzles to scrub the exterior surface, mechanical brushing, air drying and integrated systems for applying the IR coating or restoring its IR shielding performance.

Simply applying conventional and well known ‘cool roof’ paint would likely not meet the operational performance in a railroad application for an IR shield coating. There are approximately 150,000 miles of railroad track with the rails being repeatedly exposed to dust and debris from hauling coal, mining products, petroleum products, agricultural grain and the like. Any coating that requires frequent cleaning or re-application in order to maintain acceptable IR shielding performance would quickly become unaffordable and unsustainable. Consequently, IR coating technology that would be self-cleaning, still functional when the exterior surface of the IR coating has been physically covered by debris or a combination thereof, would be crucial in the long term prevention of solar induced thermal buckling and the derailments that can result.

Calcium carbonate based coatings have a natural high solar reflectivity and are significantly less expensive in comparison to titanium dioxide for example. Calcium carbonate or magnesium carbonate in the presence of atmospheric water and carbon dioxide causes a renewal of the coating's IR shielding performance.

CaCO₃ (old solid surface)+H₂O+CO₂ (atmospheric gas)→Ca(HCO₃) (aqueous calcium species)+H₂O+CaCO₃ (new solid surface)

Ca(HCO₃)−H₂O (evaporation)+heat→CaCO₃ (reformed solid surface)

When exposed to rain in the presence of atmospheric carbon dioxide, the degraded calcium carbonate surface is dissolved away. The remaining hydrogen calcium carbonate when dried out results in a new surface with the IR shielding performance having been restored. Magnesium carbonate has similar chemistry and reflective performance in this application.

Similar in infrared reflectivity performance and complimentary to calcium carbonate based chemistry would be coatings based on calcium sulfate.

Calcium sulfate has a similar self-cleaning reaction when exposed to rain and atmospheric carbon dioxide. Calcium carbonate and calcium sulfate are commonly found in hard water and caliche. Calcium sulfate would as readily available as limestone and the sulfate component causes a quick setting, self-binding feature that is not present in straight calcium carbonate chemistry.

Calcium and sulfate ions dissolved in water precipitate during evaporation resulting in crystalline calcium sulfate hydrate, which has inherent mechanical binding. Plaster of Paris is a familiar example of manmade calcium sulfate chemistry that could be used in this application and has superior binding effects.

Ca⁺ (cation)+SO4⁻ (anion) in water when it evaporates→CaSO4, and an H2O crystalline solid binder.

Another method for restoring the IR shielding performance of different coatings would be the surface application of photo-catalytic titanium dioxide. The photo-catalytic titanium dioxide reacts with atmospheric water to produce hydroxyl ions, which chemically removes common surface debris that can degrade the IR shielding performance of the coating.

Alternatively or in addition to simply reflecting the solar infrared radiation one could change, alter or shift the IR radiation into a frequency band that does not produce heat. Small particulate alumina can be added to the other ingredients and cause the infrared radiation to shift into the ultraviolet and visible range, precluding the added heat to the steel rails.

The present disclosure explains the photocatalytiic TiO2 chemistry and a bit more on the Hughes Welsbach material usage in shifting IR to low heat producing bandwidths. Self-Cleaning Photocatalytic Anatase TiO2 surfaces background: though previously used in solar powered fuel cells and in photovoltaics, the wet particle under sunlight “hydrophilic self-cleaning surface”, antimicrobial action and breakdown of organics and stains was discovered by the Japanese in 1974. It has since been method and utility patented many, many times, commercialized since the 80s, began achieving expanded usage during the 90s and currently made worldwide. We will be using a commercial liquid TiO2 silica sol coating as the top coat for the IR reflective coating. “Oxititan”™ is an example of a current, all-purpose commercial sol coating. The present disclosure adds the Welsbach particulates to this sol which distinguishes it from the prior art of record.

An embodied photo-catalyst works through a porouse n-type semiconductor anatase titanium dioxide Schottky barrier electron-hole relationship. Present day examples of material can split water with light ranging from near ultraviolet (NUV) well down into visible blue and of course it goes without saying far ultraviolet (FUV) splits water on its own, but the solar fraction is insufficient clean surfaces at low altitudes.

Natural Solar FUV Photolysis/Photooxidation: a. FUV+2 H2O=H2+OH−

Synthetic anatase TiO2 NUV Photocatalysis: b. NUV+2 H2O+O2+e=H2+O2+.OH radical (oxidative)

Both a & b occur within photocatalytic TiO2, a. gives rise to the hydrophilic self-cleaning reaction forming chains with excess water—attaches to dirt and grime OH—HOH—OH . . . in turn lifting it from the reaction surface for rain or dew to subsequently rinse off, while the resulting oxidative radical of a. in a bleaching and disinfecting reaction breaks down organics and stains to H2O+CO2.

Addition of quasi Welsbach alumina (Al2O3) particles to the above mineral sol self-cleaning top coating absorbs solar NIR radiation and reradiates it in far infrared (FIR) as is normal, but in this material, the IR radiation is also reradiated in the near ultraviolet (NUV) and visible spectra. The importance of this to the self-cleaning coating is it has more visible and NUV light content to increase hydroxyl ion and radical production to perform more work. The importance to the IR reflecting rail coating is it reduces the IR thermal gain load to both the reflective coating and rail, while the reflective coating reflects the IR back into the top coating to be further acted on by the Welsbach material.

Readily known references are silent as to the mathematic or physics beyond Stephan-Boltzman law so the origin of this feat of frequency shifting upwards to shorter wavelengths is unknown to this author unless covered in some ancient text on Welsbach materials and refractories. It may have been used in earlier NASA or military missile, or capsule coatings or ablational surfacing, possibly space blankets and far infrared heaters and ovens. It obviously has a lot more utility and life in it than covered.

Prior art is absent regarding coated IR reflective coating whether paint, metal surface oxidized to an IR reflecting pigment or metal mirror with these self-cleaning titania sols that are also clear, ie IR transparent, oxidation protective hard coats. For instance polished aluminum mirrors are typically coated with a silica sol. This provides these mirrors with a self-cleaning silica sol.

Crushed grey granite and cracked limestone are two common types of rock used as ballast. White limestone has a significantly higher solar reflectivity than grey granite and non-white limestone. When used as the IR shielding rock, Item 146, crushed white limestone would perform the same function as a solar reflective coating being applied directly to the rail in order to prevent solar radiation from heating the steel.

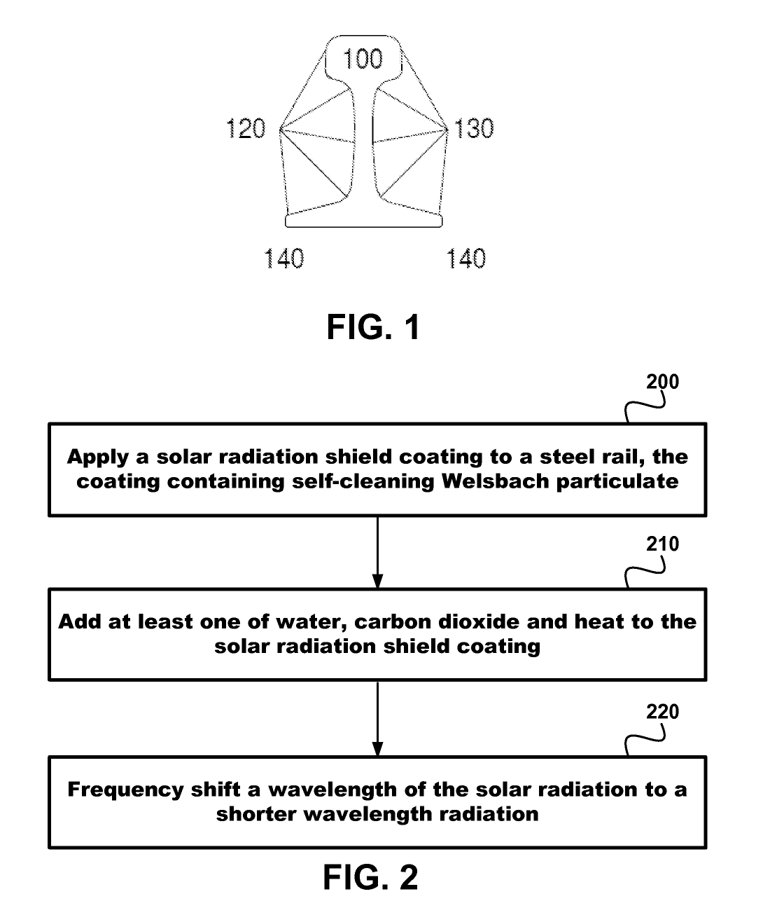

FIG. 1 is an end depiction of a typical railroad rail and the surfaces coated with a solar radiation shield configured to shield the rail and be self-cleaning in accordance with an embodiment of the present disclosure. The depiction includes the application of coatings applied to certain portions of rail, Item 100, which has already been installed in the field. Item 120 and Item 130 represents the left and right respective portions of the rail, Item 100, to be coated but not including the top of the rail, Item 100. Item 140 represents portions of the rail track structure, such as the rail tie plates, cross ties and ballast rock not depicted in this figure, to be coated in conjunction with Item 120 and Item 130 to prevent or minimize the heat buildup in steel train rails due to solar radiation.

In other words, the disclosed steel rail solar radiation shield comprises a coating applied to the steel rail configured to one of block, reflect and frequency shift solar radiation from being transferred to the steel rail via particulates suspended in the coating, the applied coating configured to be self-cleaning via at least one of additional water, carbon dioxide, heat and an additional superficial sol coating configured to shed contaminates from the applied solar radiation shield coating.

Embodiments of the applied solar radiation shield coating are self-cleaning via calcium carbonate CaCO₃ plus water plus carbon dioxide to yield an aqueous calcium species Ca(HCO₃) plus water and a new solid surface CaCO3. Also, heat applied to the aqueous calcium species Ca(HCO₃) plus water causes the water to evaporate forming a reformed solid surface CaCO₃. The water may come from rain in the presence of atmospheric carbon dioxide and a remaining dried hydrogen calcium carbonate producing a new surface comprising restored infrared shielding to the underlying rail.

Another embodiment of the additional superficial sol coating is self-cleaning via a porous n-type semiconductor anatase titanium dioxide TiO₂ via a Schottky barrier electron-hole relationship and absorbed water and photo-catalysis of natural solar far ultraviolet through visible blue range light frequencies to yield H₂ plus hydroxyl ions which chemically remove common surface debris and break down organic compounds which degrade the infrared radiation shielding performance of the coating. In other words, the additional superficial sol coating is self-cleaning via a porous n-type semiconductor anatase titanium dioxide TiO₂ via a Schottky barrier electron-hole relationship and absorbed water plus O₂ and synthetic anatase solar near ultraviolet photo-catalysis to yield H₂ plus O₂ plus an OH oxidative radical.

In an additional embodiment of the disclosure, the coating applied to the steel rail is configured to one of block, reflect and shift solar radiation transferred to the steel rail via Welsbach alumina Al₂O₃ particulates suspended in the solar radiation shield coating which absorbs near Infrared Radiation and reradiates it as far Infrared, visible and Ultraviolet Radiation.

In a further embodiment of the disclosure, the additional superficial sol coating comprises calcium sulfate plus water plus atmospheric carbon dioxide which dissolve in the water and precipitate and yield crystalline calcium sulfate hydrate which mechanically bonds to the rail. The disclosure comprises producing a crystalline solid CaSO₄ hemihydrate infrared radiation reflective surface via drying out a Calcium cation plus a Sodium anion SO₄ dissolved in water.

FIG. 2 is a flow chart of a method for frequency shifting a solar radiation wavelength to a shorter wavelength via Welsbach particulate in the solar shield in accordance with an embodiment of the present disclosure. The method includes applying 200 a solar radiation shield coating to a steel rail, the coating containing self-cleaning Welsbach particulate. The method also includes adding 210 at least one of water, carbon dioxide and heat to the solar radiation shield coating. The method further includes frequency shifting 220 a wavelength of the solar radiation to a shorter wavelength radiation to reduce the amount of energy transferred to the rail.

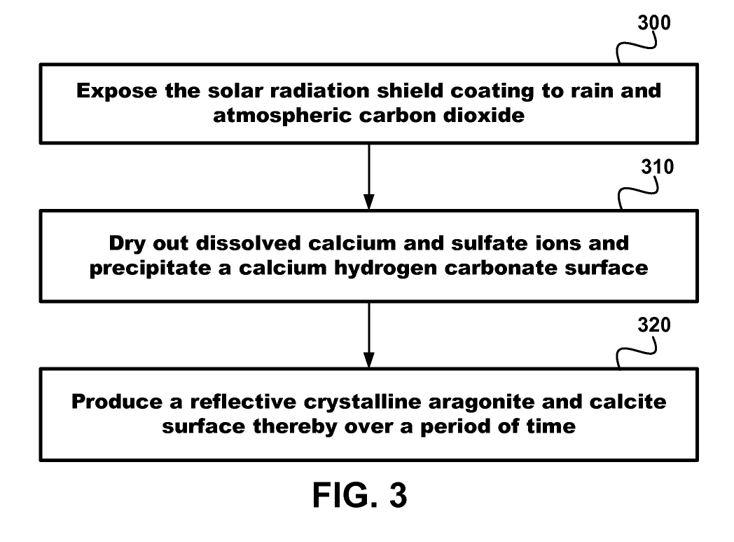

FIG. 3 is a flow chart of a method for producing a self-cleaning and reflective crystalline aragonite and calcite shield in accordance with an embodiment of the present disclosure. The method includes exposing 300 the solar radiation shield coating to at least one of rain and atmospheric carbon dioxide. The method also includes drying out 310 dissolved calcium and sulfate ions and precipitating a calcium hydrogen carbonate surface. The method further includes producing 220 a reflective crystalline aragonite and calcite surface thereby over a period of time. The surface thereof being also self-cleaning of contaminants and small surface debris.

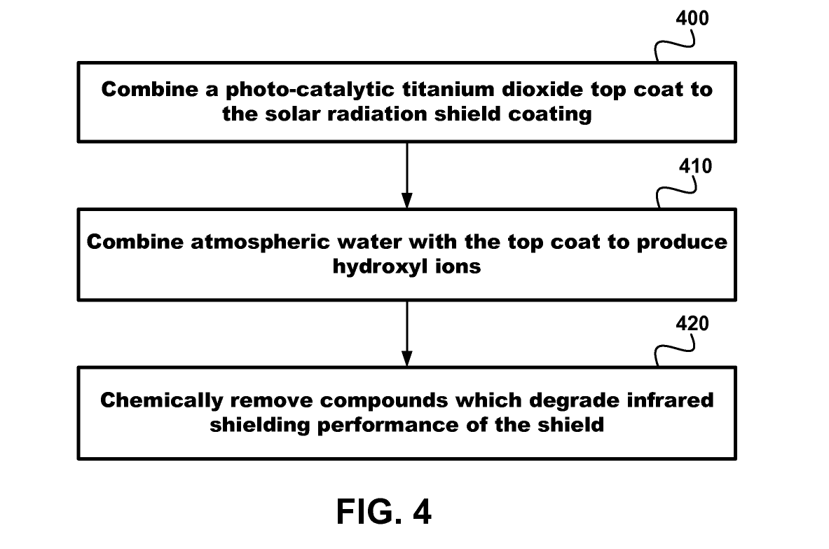

FIG. 4 is a flow chart of a method for producing a photo-catalytic titanium dioxide top coat shield that is self-cleaning in accordance with an embodiment of the present disclosure. The disclosed method includes combining 400 a photo-catalytic titanium dioxide top coat to the solar radiation shield coating and combining 410 the top coat plus atmospheric water to produce hydroxyl ions. The method further includes chemically removing 420 common surface debris and breaking down organic compounds which degrade the infrared radiation shielding performance of the shield.

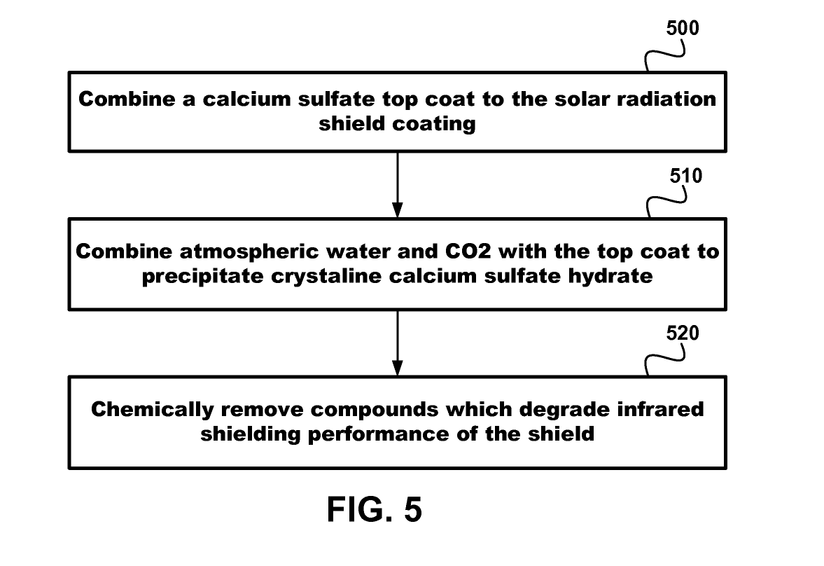

FIG. 5 is a flow chart of a method for producing a crystalline calcium sulfate hydrate shield that is self-cleaning in accordance with an embodiment of the present disclosure. Another embodiment of the disclosure may include combining a calcium sulfate top coat to the solar radiation shield coating, the top coat plus water plus atmospheric carbon dioxide dissolving in the water and precipitating to yield crystalline calcium sulfate hydrate which mechanically bonds to the rail. Therefore, an infrared reflectivity of the sol coating improves as the coating desiccates.

The disclosed method may include applying the solar radiation shield coating to a plurality of proximal components including tie plates, cross ties and a proximal portion of a ballast bed, the additional coating configured to impede solar radiation from heating the steel rail via conduction from the proximal track structures.

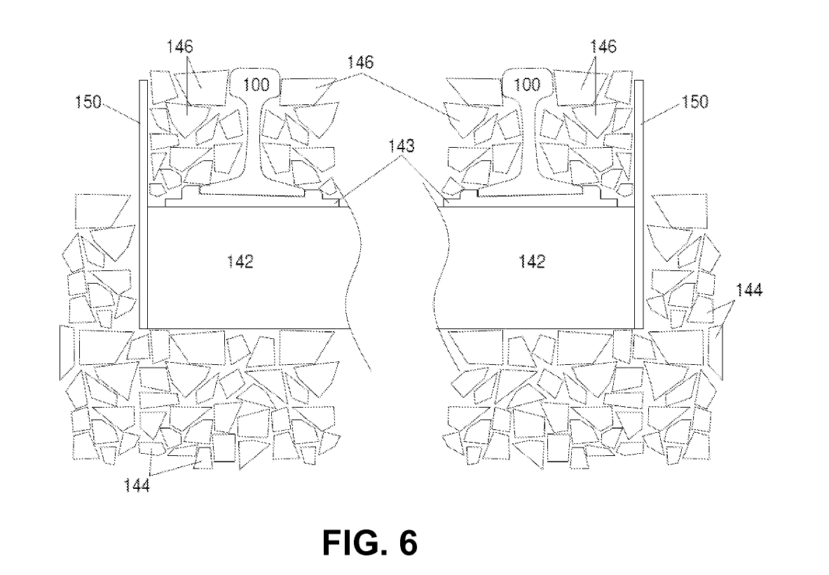

FIG. 6 depicts a front elevational view of a pair of installed rails and a side wall ballast retaining shield that has self-cleaning properties in accordance with an embodiment of the present disclosure. The depiction shows a different means for shielding the steel rails from the solar infrared radiation. In this representation the steel rail, Item 100, and underlying track structure are shielded from the solar radiation by heaping rock, such as white limestone, up to the top of the steel rails. To prevent subsidence by the accumulated IR shielding rock, it would be physically retained by Item 150 on the outside of both rails. Item 142 are the cross ties which reside within the ballast rock. Rail tie plates, Item 143 are used in conjunction with rail fasteners, not shown, for affixing the rail, Item 100, to the cross ties, Item 142. Item 144 are the ballast rock underneath, between and outside the ends of the cross ties. Item 150 are the side walls that retain the upper IR shielding rock, Item 146.

In other words, a steel rail solar radiation shield comprises a side wall retaining shield configured parallel to and distal to at least one rail, the side walls thereof extending to a height near a top of the rail(s) from a base for the rail(s) comprising a plurality of cross ties and a supporting structure for the rail(s), the side wall retaining shield configured to retain a ballast configured to block and reflect the solar radiation from the steel rail(s) and have self-cleaning properties. The ballast comprises a crushed white limestone rock disposed to block infrared radiation from all sides of the rails other than a top and a bottom surface of the rails in relation to the base, the limestone rock configured to comprise free calcium sulfate to hydrate in the rain water and yield crystalline calcium sulfate which mechanically bonds to the rail and chemically sheds contaminates in the water to continually produce an infrared radiation reflective shield. A dual-wall sidewall shield for each of a plurality of parallel single rails may be used or one dual-wall sidewall shield for a plurality of rails therein. The side walls may comprise one of a metallic material, a chemically treated wood, rock and an earthen-rock composite wall.

Although the components herein are shown and described in a particular order, the order thereof may be altered so that certain advantages or characteristics may be optimized In another embodiment, instructions or sub-operations of distinct steps may be implemented in an intermittent and/or alternating manner.

Notwithstanding specific embodiments of the invention have been described and illustrated, the invention is not to be limited to the specific forms or arrangements of parts so described and illustrated. The scope of the invention is to be defined by the claims and their equivalents.

What is claimed is:

1. A steel rail solar radiation shield, comprising a coating applied to the steel rail configured to one of block, reflect and frequency shift solar radiation from being transferred to the steel rail via particulates suspended in the coating, the applied coating configured to be self-cleaning via at least one of additional water, carbon dioxide, heat and an additional superficial sol coating configured to shed contaminates from the applied solar radiation shield coating.

2. The steel rail solar radiation shield of claim 1, wherein the applied solar radiation shield coating is self-cleaning via calcium carbonate CaCO₃ plus water plus carbon dioxide to yield an aqueous calcium species Ca(HCO₃) plus water and a new solid surface CaCO₃.

3. The steel rail solar radiation shield of claim 2, further comprising heat applied to the aqueous calcium species Ca(HCO₃) plus water causes the water to evaporate forming a reformed solid surface CaCO₃.

4. The method of restoring a steel rail solar radiation shield of claim 3, wherein the water comes from rain in the presence of atmospheric carbon dioxide and a remaining dried hydrogen calcium carbonate producing a new surface comprising restored infrared shielding to the underlying rail.

5. The steel rail solar radiation shield of claim 1, wherein the additional superficial sol coating is self-cleaning via a porous n-type semiconductor anatase titanium dioxide TiO₂ via a Schottky barrier electron-hole relationship and absorbed water and photo-catalysis of natural solar far ultraviolet through visible blue range light frequencies to yield H₂ plus hydroxyl ions which chemically remove common surface debris and break down organic compounds which degrade the infrared radiation shielding performance of the coating.

6. The steel rail solar radiation shield of claim 1, wherein the additional superficial sol coating is self-cleaning via a porous n-type semiconductor anatase titanium dioxide TiO₂ via a Schottky barrier electron-hole relationship and absorbed water plus O₂ and synthetic anatase solar near ultraviolet photo-catalysis to yield H₂ plus O₂ plus an OH oxidative radical.

7. The steel rail solar radiation shield of claim 1, wherein the coating applied to the steel rail is configured to one of block, reflect and shift solar radiation transferred to the steel rail via Welsbach alumina Al₂O₃ particulates suspended in the solar radiation shield coating which absorbs near Infrared Radiation and reradiates it as far Infrared, visible and Ultraviolet Radiation.

8. The steel rail solar radiation shield of claim 1, wherein the additional superficial sol coating comprises calcium sulfate plus water plus atmospheric carbon dioxide which dissolve in the water and precipitate and yield crystalline calcium sulfate hydrate which mechanically bonds to the rail.

9. The steel rail solar radiation shield of claim 8, further comprising producing a crystalline solid CaSO₄ hemihydrate infrared radiation reflective surface via drying out a Calcium cation plus a Sodium anion SO₄ dissolved in water.

10. A method of shielding a steel rail from solar radiation, comprising applying a solar radiation shield coating thereto and frequency shifting a wavelength of the solar radiation to a shorter wavelength radiation, the applied solar radiation shield coating containing Welsbach particulate configured to be self-cleaning by the application of at least one of additional water, carbon dioxide and heat.

11. The method of shielding a steel rail from solar radiation of claim 10, comprising:
exposing the solar radiation shield coating to rain in the presence of atmospheric carbon dioxide;
drying out dissolved calcium and sulfate ions and precipitating a calcium sulfate surface thereof; and
producing a reflective calcium sulfate anhydrite surface thereby over a period of time.

12. The method of shielding a steel rail from solar radiation of claim 10, further comprising combining a photo-catalytic titanium dioxide top coat to the solar radiation shield coating, the top coat plus atmospheric water producing hydroxyl ions and chemically removing common surface debris and break down organic compounds which degrade the infrared radiation shielding performance of the shield.

13. The method of shielding a steel rail from solar radiation of claim 10, further comprising a calcium sulfate solar radiation shield coating, the coating plus water plus atmospheric carbon dioxide dissolving in the water and precipitating to yield crystalline calcium sulfate hydrate which mechanically bonds to the rail.

14. The method of shielding a steel rail from solar radiation of claim 13, further comprising improving an infrared reflectivity of the coating as the coating desiccates.

15. The method of shielding a steel rail from solar radiation of claim 10, further comprising applying the solar radiation shield coating to a plurality of proximal components including tie plates, cross ties and a proximal portion of a ballast bed, the additional coating configured to impede solar radiation from heating the steel rail via conduction from the proximal track structures.

16. A steel rail solar radiation shield comprising a side wall retaining shield configured parallel to and distal to at least one rail, the side walls thereof extending to a height near a top of the rail(s) from a base for the rail(s) comprising a plurality of cross ties and a supporting structure for the rail(s), the side wall retaining shield configured to retain a ballast configured to block and reflect the solar radiation from the steel rail(s) and have self-cleaning properties.

17. The steel rail solar radiation shield of claim 16, wherein the ballast comprises a crushed white limestone rock disposed to block infrared radiation from all sides of the rails other than a top and a bottom surface of the rails in relation to the base, the limestone rock configured to comprise free calcium sulfate to hydrate with rain water and yield crystalline calcium sulfate which mechanically bonds to the rail to produce an infrared radiation reflective shield.

18. The steel rail solar radiation shield of claim 16, further comprising a dual-wall sidewall shield for each of a plurality of parallel single rails.

19. The steel rail solar radiation shield of claim 16, further comprising one dual-wall sidewall shield for a plurality of rails therein.

20. The steel rail solar radiation shield of claim 16, wherein the side walls comprise one of a metallic material, a chemically treated wood, rock and an earthen-rock composite wall.
